(19) United States
(12) Patent Application Publication
(10) Pub. No.: US 2004/0256831 A1
(43) Pub. Date: Dec. 23, 2004

(54) Vehicle suspension

(76) Inventor: Keith Leslie Sharp, Nantwich (GB)

Correspondence Address: SALTER & MICHAELSON, THE HERITAGE BUILDING, 321 SOUTH MAIN STREET, PROVIDENCE, RI, 029037128

(21) Appl. No.: 10/468,576

(22) PCT Filed: Feb. 21, 2002
(86) PCT No.: PCT/GB02/00737

(30) Foreign Application Priority Data
Feb. 22, 2001 (GB) 0104491.6

(51) Int. Cl. B60G 11/26

(52) U.S. Cl. 280/124.157

(57) ABSTRACT

A suspension system for a vehicle comprises a number of individual suspension units. Each unit comprises an airspring (2) and an actuator (3). Units are disposed adjacent respective wheels of the vehicle. Units (21) and 22 on the same axle are connected by an airspring comprising a pipe (20). In a roll condition, air is displaced from actuator (3) to airspring (2) on the outer suspension unit, while, on the inside suspension unit, the effective shared volume between the actuator (3) and airspring (2) is increased to control roll. Pitch may also be controlled by actuating the actuators (3) of the units adjacent the front wheels of a four wheel vehicle to displace air to the corresponding airsprings (2) and the actuator (3) of the units adjacent the rear wheels to increase the shared volumes of the actuators (3) and corresponding airsprings (2) under the control of an electrical control unit.

The present invention relates to a vehicle suspension system.

Suspension systems can be divided into three groups; fully active, slow active and passive.

For fully active systems the operational frequency is from 0 to above wheel-hop frequency (10-15 Hz), including both body motions and vibrations. For slow active systems the operational frequency is from 0 to 3-6 Hz. A slow-active suspension generates forces to the suspension to control vehicle body motions, also referred as a narrow bandwidth system due to limited operation range. In a switchable system body motions and ride characteristics are controlled by changing spring or damper stiffness. This does not generate forces into suspension. (By the definition; a passive active suspension). In the case of a fully active suspension, an actuator replaces the conventional passive suspension elements such as the spring and damper. To achieve good performance, the actuator control bandwidth typically extends above the wheel-hop natural frequency (10-15 Hz). Although the technology and knowledge to design and manufacture a fully active suspension system is already well known and proven, its feasibility is not. With current technology, limitations exist in the cost, packaging and power consumption. Also beyond the actuator bandwidth the noise and vibration is likely to be a problem, unless some significant flexibility is added in series with the suspension strut, for example by way of rubber bushes.

One way to reduce the force required to control body attitude changes and consequently the actuator power consumption is to place an actuator in series with a passive spring, as in narrow bandwidth systems, also referred as slow-active systems in the literature. With this arrangement, the lower frequency active control, typically up to 3 Hz, is applied to react between the sprung mass and passive suspension. Higher frequencies are isolated by the passive suspension. However, slow-active systems still partly share the same noise and vibration disadvantages as the fully active systems, due to the conventional spring in series.

Many manufacturers have found that the use of an air spring as a passive element has offered an improvement to the slow active system. The active part in these systems has usually been separated from the air spring (adaptive damping, actuator in series, etc.) or it has been a switchable volume type. The switchable type uses a supplementary air reservoir(s) to control wheel travel more effectively. A common disadvantage for all these systems, which use on/off type switching, is that the amount of variation is limited. If the switching is applied instantly when required, an unwanted effect may occur. This effect may be felt as vibration or even worse as a jerk, which may affect the vehicle behaviour. Two examples of known systems are the air suspension system with adaptive damping described in GB 2,287,300A and a switchable valve operated switchable system which changes spring stiffness between two volumes, using an additional air reservoir as described in EP 0,864,452A.

An object of the present invention is to overcome or mitigate the above described disadvantages.

According to the present invention there is provided a suspension unit for a vehicle comprising an actuator and an airspring and a connection between the actuator and the air spring to enable air to pass between them.

In a preferred embodiment of the invention, the actuator comprises a piston disposed in a cylinder. The piston may be driven by an electric or hydraulic drive. The airspring also comprises a piston and cylinder. The connection between the actuator and airspring advantageously comprises a pipe preferably connected between respective cylinders of the actuator and airspring. Two units are disposed at opposite ends of the or each axle of the vehicle. Advantageously, the actuators of the two units are connected to provide an energy save characteristic in which energy is transferred from one unit to the other under vehicle body roll conditions. The connection may comprise an airspring or a mechanical spring preferably a helical spring. The airspring may comprise a pipe connecting the cylinders of the two actuators. The mechanical spring may mechanically connect the pistons of the two actuators. An electrical control unit is advantageously provided to control the operation of the actuators. Sensors measure various parameters and produce signals which are fed to the ECU. These are evaluated by the ECU and control signals transmitted to the actuators to control roll. The parameters include steering wheel angle, lateral acceleration, throttle position, various body state and driver inputs. The above described actuator may have other forms for example, airspring diaphragm type or rubber bellows type actuators may be used.

In order that the invention may be more clearly understood, embodiments thereof will now be described, by way of example, with reference to the accompanying drawings, in which:

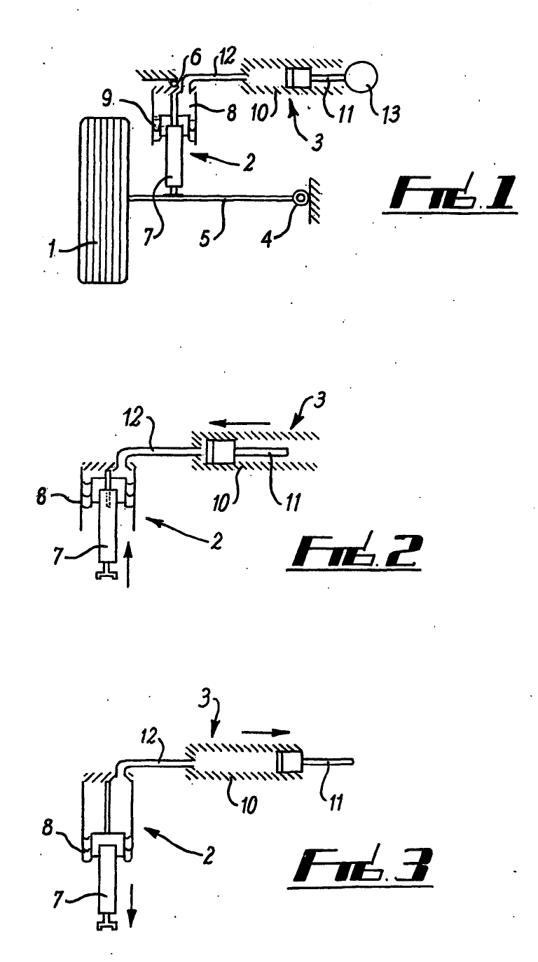

FIG. 1 diagrammatically shows a suspension unit for one wheel of a vehicle,

FIG. 2 diagrammatically shows the unit of FIG. 1 when disposed on one side (the outside) of a vehicle subject to a roll condition,

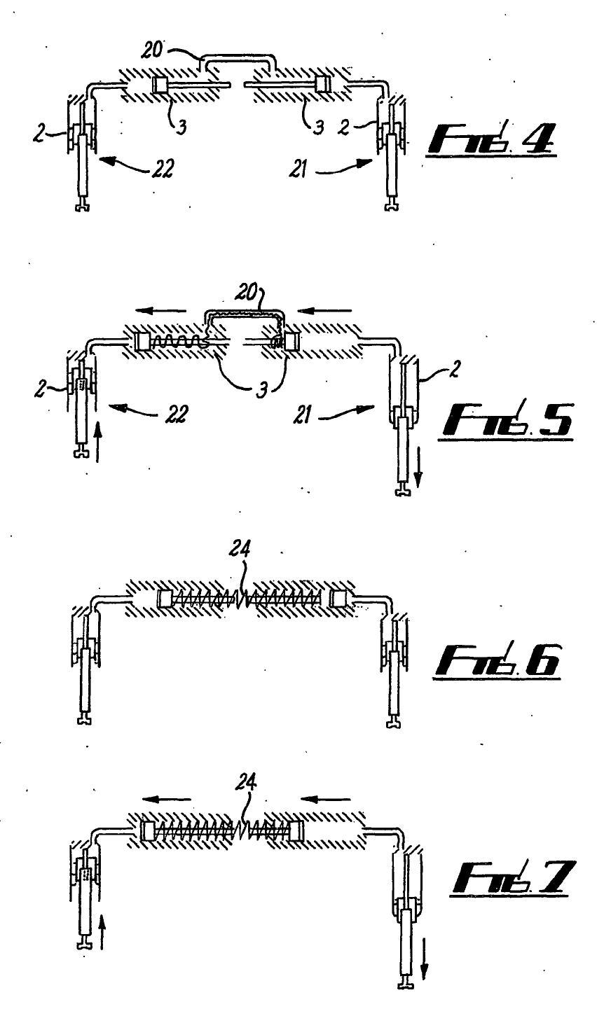

FIG. 3 diagrammatically shows the unit of FIG. 1 when disposed on the other side (the inside) of a vehicle subject to a roll condition,

FIG. 4 diagrammatically shows two suspension units on opposite sides respectively of the same axle when the vehicle is travelling in a straight line,

FIG. 5 diagrammatically shows two suspension units on opposite sides respectively of the same axle,

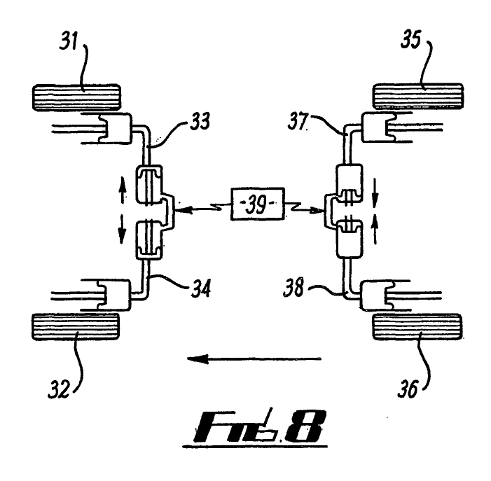

FIG. 6 corresponds to FIG. 4 for an alternative arrangement to that shown in FIG. 4,

FIG. 7 corresponds to FIG. 5 for an alternative arrangement to that shown in FIG. 5, and

FIG. 8 diagrammatically shows four suspension units for a four wheeled vehicle with the vehicle in a pitch condition.

Referring to FIG. 1, the suspension unit is shown connected to wheel 1 of a vehicle. The unit comprises an air spring 2 and an actuator 3. The wheel is connected to the vehicle body at point 4 through suspension member 5. The air spring 2 is connected between suspension member 5 and a further point 6 on the vehicle. The air spring 2 comprises a piston 7 connected to member 5 and cylinder 8 connected to the vehicle body at 6 and between which a flexible seal 9 is disposed. The actuator 3 comprises a cylinder 10 in which a piston 11 is disposed. The piston 11 may be driven in the cylinder 10 by means of an electric or hydraulic drive 13. The cylinders 8 and 10 are connected by means of a pipe 12 so that the air spring and actuator share a common air volume. This shared air volume may be charged infinitely within the limits of actuator 3 operation. This arrangement enables the conventional spring, which is largely responsible for transmitting vibrations from the wheel to the vehicle body, to be removed from the system. Because of added softness in the suspension and spring stiffness adjustability, the system will yield an improvement in ride compared to known slow-active suspensions, which suffer refinement problems outside the actuators operation area. The position of the actuator may be varied in dependence upon the length of the connection pipe 12 although for practical reasons it is better for this pipe to have a shorter rather than a longer length. The actuator may be any one of a number of different types. For example, instead of the cylinder piston type actuator illustrated in FIG. 1, an airspring type of diaphragm actuator or a rubber bellows type of actuator may be used. Whatever design is chosen, the aim is to compress and decompress the total volume to specified size, to achieve a target spring stiffness.

The suspension shown in FIG. 1 is shown with the spring and actuator in the positions they would adopt with the vehicle travelling in a straight line. This is the case whichever side of the vehicle the suspension is disposed on. The suspension as shown in FIGS. 2 and 3 is shown for the vehicle when subjected to roll or lateral acceleration, when cornering. FIG. 2 shows the position for the suspension disposed on the outside of the vehicle and FIG. 3 the inside of the vehicle. As can be seen in FIG. 2, the piston 11 of the actuator 3, as compared with the normal position shown in FIG. 1, has been driven to displace air from the cylinder 10 to the cylinder 8. The piston 9 has moved to compress the air in the cylinder 8 of the air spring 3. If under this roll condition the actuator pistons of the two suspension units did not move, the suspension would act like a normal passive airspring suspension. When the vehicle starts to corner sensors sense the lateral acceleration and steering wheel position. Further sensors sense yaw, the position of the vehicle relative to the suspension springs, throttle position and other parameters. Signals representing all these parameters are fed to an electronic control unit (ECU). The ECU evaluates all of these inputs and produces output signals for the actuators for roll control. In order to avoid body lift (jacking), due to added force into the outside wheel units, the inside spring stiffness must be reduced by an equal amount, so that the total axle force stays constant. Hence, in FIGS. 2 and 3 the actuator pistons have moved simultaneously in opposite directions. However, due to the inherent character of gas the displacements (swept volumes) are not equal. This is a significant factor, especially when considering the energy save layout.

In terms of energy demand, the outside wheel actuator requires an amount of energy, to support the vehicles static load and control the roll, while the inside unit releases the same amount of potential energy. This energy requirement may be balanced by the energy released by providing an energy save connection between the two suspension units on opposite sides of the vehicle. The energy save connection may be provided by an airspring as shown in FIGS. 4 and 5. The airspring comprises a pipe 20 connecting the cylinders 10 of the actuators 3 of the suspension units 21 and 22 on the inside and outside respectively of the vehicle. FIG. 4 shows the positions of the air springs 2 and actuators 3 when the vehicle is travelling in a straight line. In that condition the springs and actuators of the two suspension units adopt the same or a closely similar position. FIG. 5 shows the position of the air springs 2 and actuators 3 when the vehicle is in a roll condition. In that condition, the piston of the actuator 3 of the outside suspension unit 22 moves to displace air to the corresponding airspring 2 while the piston of the actuator 3 of the inside suspension unit 21 moves to increase the effective shared volume between the actuator 3 and the airspring 2.

A similar situation obtains in the alternative embodiment shown in FIGS. 6 and 7. In this embodiment the normal straight line position is shown in FIG. 6 and the roll position in FIG. 7. The airspring constituted by pipe 20 of FIGS. 4 and 5 is replaced by a coil spring 24. This coil spring acts in a manner similar to the airspring of FIG. 4 and 5 to transfer energy from the actuator 3 of the inside suspension unit 21 to the actuator 3 of the outside suspension unit 22 under roll conditions as shown in FIG. 7.

The system may also be employed to control pitch which occurs, for example during braking. Referring to FIG. 8, a four wheeled vehicle is shown comprising four suspension units respectively associated with the four wheels of the vehicle. The front wheels are referenced 31 and 32 and associated front suspension units 33 and 34 and the rear wheels are referenced 35 and 36 and associated rear suspension units 37 and 38. Pitch is controlled by actuating the pistons 11 of the actuators 3 of the front suspension units 32 and 33 to displace air to the corresponding

1. A suspension unit for a vehicle comprising an actuator and an airspring and a connection between the actuator and the air spring to enable air to pass between them the actuator and the air spring.

2. [[A]] The suspension unit as claimed in of claim 1, in which wherein the actuator comprises a piston and cylinder.

3. [[A]] The suspension unit as claimed in of claim 2, in which wherein the piston is adapted to be driven by an electric drive.

4. [[A]] The suspension unit as claimed in of claim 2, in which wherein the piston is adapted to be driven by a hydraulic drive.

5. [[A]] The suspension unit as claimed in any preceding of claim 1, in which wherein the airspring comprises a piston and cylinder.

6. The suspension unit as claimed in any preceding of claim 1, in which wherein the connection between the actuator and the airspring comprises a pipe.

7. [[A]] The suspension unit as claimed in of claim 6, in which wherein the actuator and airspring each comprise[[s]] a piston and a cylinder and the pipe is peferably connected between the cylinders.

8-20 (Canceled)

21. A suspension system comprising two suspension units as claimed in claim 1.

22. The suspension system of claim 21, wherein the two units are disposed at opposite ends of a vehicle axle.

23. The suspension system of claim 21, wherein a connection connects the actuators of the two units together to provide an energy save characteristic in which energy is transferred from one unit to the other unit under vehicle roll conditions.

24. The suspension system of claim 22, wherein a connection connects the actuators of the two units together to provide an energy save characteristic in which energy is transferred from one unit to the other unit under vehicle roll conditions.

25. The suspension system of claim 23, wherein the connection comprises an airspring.

26. The suspension system of claim 24, wherein the connection comprises an airspring.

27. The suspension system of claim 25, wherein the airspring comprises a pipe connecting the two actuators.

28. The suspension system of claim 26, wherein the airspring comprises a pipe connecting the two actuators.

29. The suspension system of claim 27, wherein the actuators each comprise a piston and cylinder, and the pipe connects the two cylinders.

30. The suspension system of claim 28, wherein the actuators each comprise a piston and cylinder, and the pipe connects the two cylinders.

31. The suspension system of claim 23, wherein the connection comprises a mechanical spring.

32. The suspension system of claim 24, wherein the connection comprises a mechanical spring.

33. The suspension system of claim 31, wherein the mechanical spring is a helical spring.

34. The suspension system of claim 32, wherein the mechanical spring is a helical spring.

35. The suspension system of claim 31, wherein the actuators each comprise a piston and a cylinder device, and the mechanical spring mechanically connects the two pistons.

36. The suspension system of claim 32, wherein the actuators each comprise a piston and a cylinder device, and the mechanical spring mechanically connects the two pistons.

37. The suspension system of claim 33, wherein the actuators each comprise a piston and a cylinder device, and the mechanical spring mechanically connects the two pistons.

38. The suspension system of claim 34, wherein the actuators each comprise a piston and a cylinder device, and the mechanical spring mechanically connects the two pistons.

39. The suspension system of claim 8, further comprising an electrical control unit constructed and arranged to control the operation of the actuators.

40. The suspension system of claim 38, further comprising at least one sensor constructed and arranged to measure parameters and to feed representative signals to the electrical control unit.

41. The suspension system of claim 39, wherein the electrical control unit is connected to the actuators and is operative to receive signals from the sensors and transmit control signals to the actuators to control roll.

42. A suspension system comprising two pairs of suspension units as claimed in claim 8, wherein the pairs are respectively adapted to be associated with the front and rear wheels of a four wheel vehicle and the actuators of the units are operative under the control of an electrical control unit to control pitch of the vehicle.
